(19) United States
(12) Patent Application Publication
(10) Pub. No.: US 2008/0066686 A1
(43) Pub. Date: Mar. 20, 2008

(54) Pet burrow

(76) Inventors: Frances E. Lockwood, Georgetown, KY (US); Elsie A. Jordan, Temecula, CA (US)

Correspondence Address: JAMES M. FRANCIS, 300 W VINE ST, STOLL KEENON OGDEN PLLC, LEXINGTON, KY, 40507, US

(21) Appl. No.: 11/522,654

(22) Filed: Sep. 18, 2006

(51) Int. Cl. A01K 29/00

(52) U.S. Cl. 119/28.5

(57) ABSTRACT

A pet enclosure that permits burrowing pets, such as dogs, to burrow through a tunnel like structure possessing an open end and a closed end that will permit the animal's exit by pushing the end open. The device has the benefit of providing both mental and physical stimulation for the animal.

### BACKGROUND OF THE INVENTION

1. Field of the Invention

This invention generally relates to domestic pet bedding and domestic pet exercise equipment. More particularly, this invention relates to a domestic pet bedding and exercise device formed into the shape of a tunnel. Even more particularly, this invention relates to a domestic pet bedding and exercise device formed into the shape of a tunnel with an entrance that remains open and an exit that is collapsed upon itself to promote burrowing by the pet and thereby providing exercise and mental stimulation.

2. Problems in the Art

A common problem for the owners of pets is that they require exercise for their physical well-being as well as stimulation for mental health. Often, especially with urban professionals, there is little time for enough interaction with their pets to ensure an ample supply of both exercise and stimulation. There is also a problem with space in cramped urban apartment living. Ideally a single device could provide exercise, stimulation, and serve an additional function such as a bed. The bedding should also be ornamental in appearance so as to be visually pleasing and not detract from household aesthetics.

U.S. Pat. No. 4,008,687 by Keys (Feb. 22, 1977) depicts a sleeping nook shaped in the form of an oversized slipper open on the ends resembling the heel and toe. The arched roof of the sleeping nook is kept open by the addition of a stiffener element. The stiffener element keeps the heel and toe ends from collapsing and closing.

U.S. Pat. No. 4,169,428 by Waugh (Oct. 2, 1979) describes a domestic pet sleeping bag intended to allow pets to burrow under a layer of material. However, Waugh fails to disclose a stiffening member or other means to prevent the opening of the sleeping bag from collapsing on itself and further fails to disclose an exit through which the pet can completely burrow or tunnel through the bag.

U.S. Pat. No. 4,893,586 by Carson (Jan. 16, 1990) describes a domestic pet sleeping bag that solves the problem of the collapsing opening found in the aforementioned '428 patent by the inclusion of two stiffening members to force the entrance of the sleeping bag to remain open. However, the Carson device fails to incorporate an exit of either a closed or open configuration thereby preventing the pet from burrowing or tunneling through the device as in the present invention.

U.S. Pat. No. 5,749,314 by Pelham (May 12, 1998) depicts a covered dog bed with an entrance kept open by at least one stiffening member but fails to disclose the inclusion of an exit of any kind.

### OBJECTS OF THE INVENTION

It is an object of the invention to provide bedding for domestic animals kept as household pets.

It is another object of the invention to provide pet bedding that is easy to manufacture.

It is still another object of the invention to provide a device that allows pets to burrow through a collapsed end that is reached through a tunnel from an open entrance.

### SUMMARY OF THE INVENTION

This invention provides an exercise device for burrowing domestic pets that can double as bedding if sufficiently voluminous enough for the pet to seek shelter. The device provides a tubular tunnel for that possesses an open first end that facilitates entry by the pet and a closed second end through which the pet can burrow. The tunnel is preferably either cylindrical or conical in shape but can take on other geometric configurations. The tunnel may incorporate twists, turns, and changes in elevation to further challenge the pet and provide mental stimulation.

Ideally the device is constructed by creating a sleeve of fabric in which a tunnel support member is inserted. The tunnel support member can, but does not have to, traverse the length of the tunnel. Additionally, the open first end of the tunnel can be further supported by end support members such as structural foam, plastic sheeting, cardboard sheeting, cardboard tubing, plastic tubing, wire and similar materials known to those skilled in the art. The end support members can be used either alone or in conjunction with the tunnel support member as neither requires the other to perform its intended function.

Ideally the tunnel and end support members are removable so that the sleeve can be washed. The sleeve is anticipated to be closed around the support members by buttons, zippers, VELCRO™, snaps, hooks, or similar fastening mechanisms known to those skilled in the art.

An additional embodiment would incorporate a cuff around the open first end. This cuff would fold back onto outside or inside of the tunnel itself and would conceal an end support member that ideally would follow either encompass the outside of the tunnel wall at the open first end or would encompass the cuff folded into the open first end of the tunnel.

The closed second end is ideally closed by means of a curtain formed by excess material hanging over the second end of the tunnel. In an alternative embodiment, the second end could be closed by the tunnel wall itself due to the shape of the tunnel support member. In this embodiment, the tunnel support member is rigid enough to maintain the structural integrity of the tunnel while being flexible enough to permit a pet to burrow through by forcing the second end open.

### BRIEF DESCRIPTION OF THE DRAWINGS

FIG. 1a depicts a perspective view of the preferred embodiment of the invention as seen from the open end.

FIG. 1b depicts a perspective view of the preferred embodiment of the invention as seen from the closed end.

FIG. 2 depicts a perspective view of an embodiment of the invention in which the tunnel is cylindrically shaped.

FIG. 3 depicts a perspective view of an embodiment of the invention in which the tunnel is conically shaped.

FIG. 4 depicts a cutaway perspective view of an embodiment of the invention in which the open end or first end is supported by an end support member inserted within the tunnel wall at the open end or first end.

FIG. 5 depicts a cutaway perspective view of an embodiment of the invention in which the open end or first end is supported by an end support member encompassing the open end or first end of the tunnel outside of the outer surface of the tunnel wall but beneath a cuff folded back over the top of the end support member.

FIG. 6 depicts a cutaway perspective view of an embodiment of the invention in which the ends of the rolled tube are joined rather than overlap.

### DETAILED DESCRIPTION OF THE INVENTION

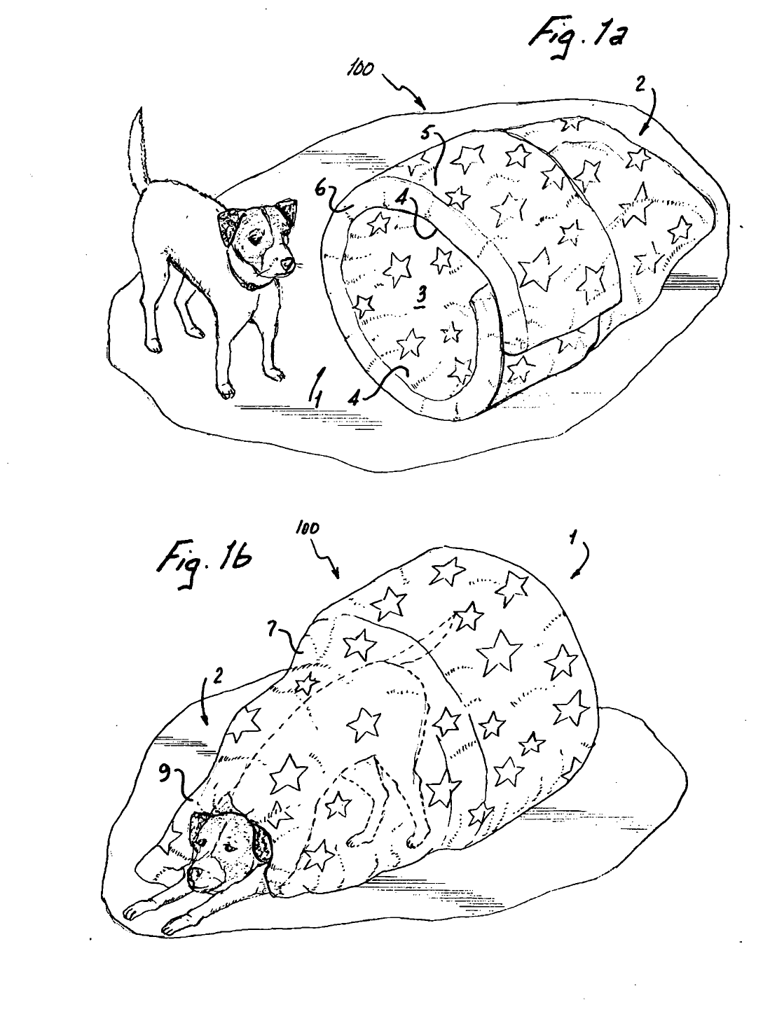

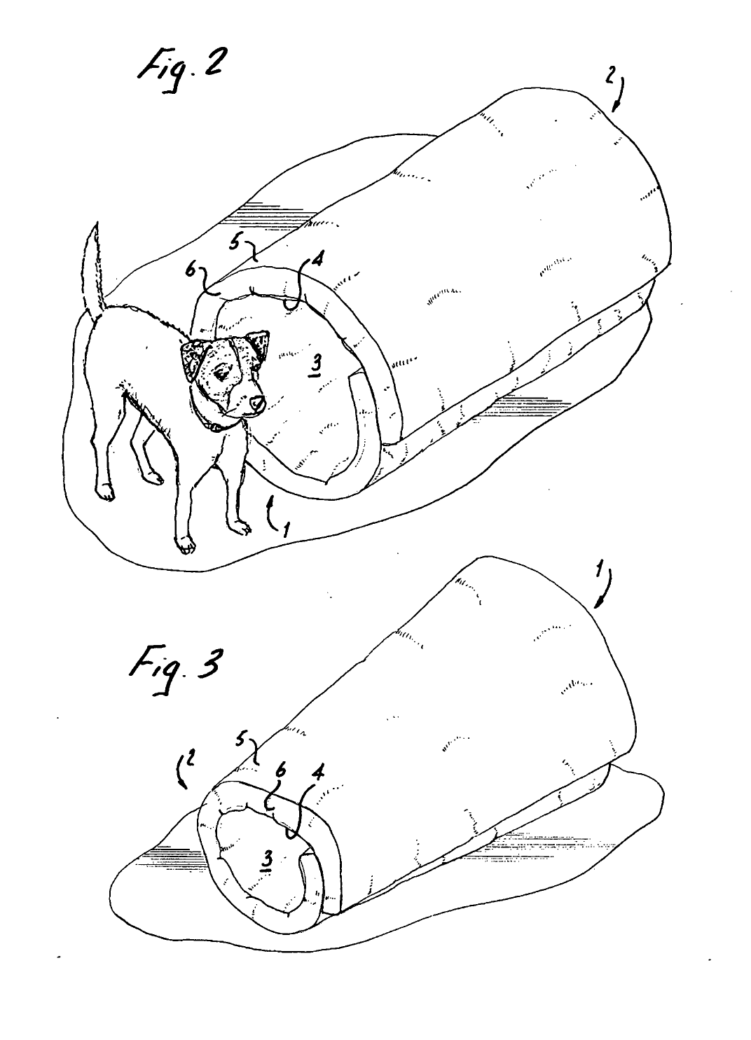

Referring to the drawings, the preferred embodiment of the pet burrow 100 is shown in FIG. 1a. The pet burrow has a first end 1 that remains open, a second end 2 that is closed in such a way that it can be forced opened by the burrowing action of a pet. Between the first end 1 and the second end 2, the device possesses a tube-like tunnel 3. Ideally there will be sufficient distance between the first end 1 and the second end 2 so that the tunnel 3 and have a diameter from inner wall 4 to inner wall 4 across the tunnel 3 sufficient to accommodate the body of the pet for which it is intended. The thickness of the pet burrow 100 is determined by the distance between the inner surface 4 and the outer surface 5 of the tunnel wall 6.

The first end 1 is kept open by either the structural integrity of the tunnel 3 or the separate structural integrity of the first end 1. The separate structural integrity of the first end 1 can alternatively be imparted by materials either inserted into or around the tunnel wall 6 at the first end 1.

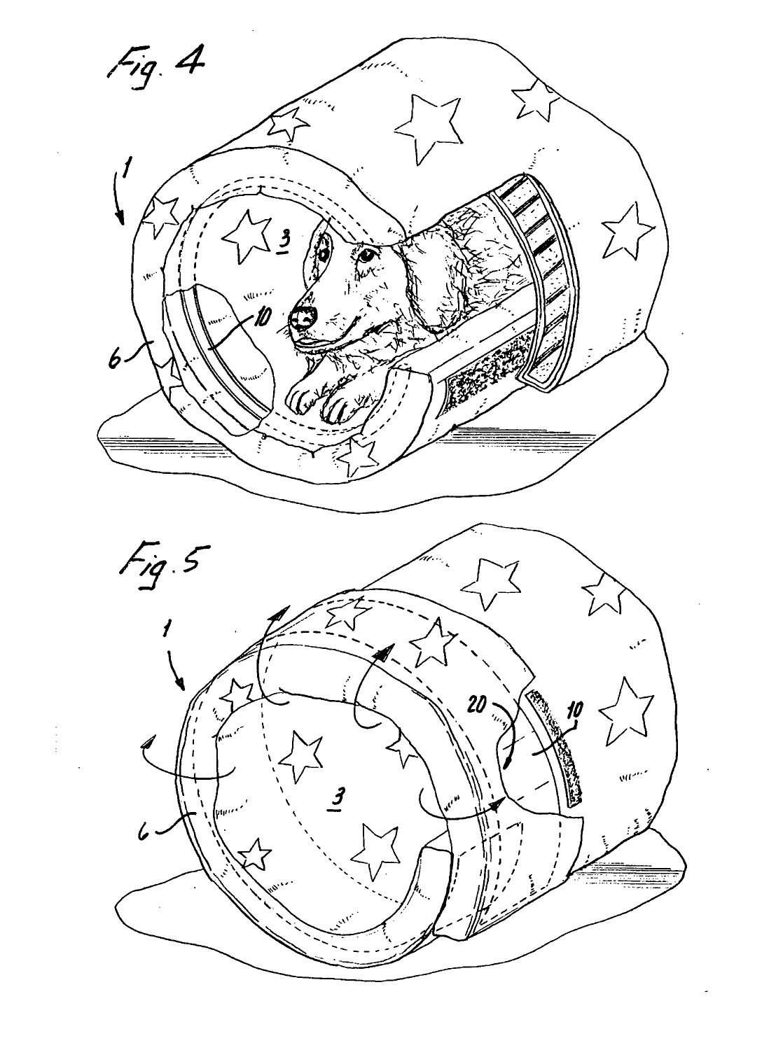

The tunnel 3 is ideally cylindrical, as depicted in FIG. 2, or conical, as depicted in FIG. 3. Other shapes are anticipated to be easily achieved by the use of shaped structural reinforcements inserted into or encompassing the length of the tunnel wall 6 and/or the portion of the tunnel wall 6 forming the first end 1.

As depicted in FIG. 4, the first end 1 can be kept open by the insertion of an end support member 10 within the tunnel wall 6 at the first end 1 that encompasses the opening at the first end 1 either entirely or sufficiently to keep the first end 1 from collapsing upon itself.

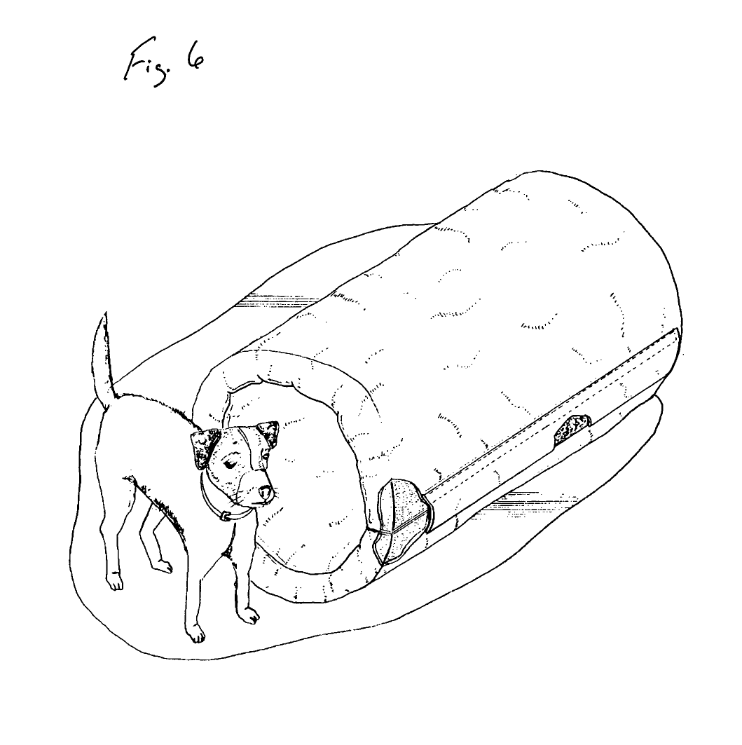

As depicted in FIG. 5, the first end 1 can be kept open by the insertion of an end support member 10 within a cuff 20 that encompasses the tunnel wall 6 at the first end 1 either entirely or sufficiently to keep the first end 1 from collapsing upon itself.

As depicted in FIG. 1b, the second end 2 is ideally closed by a curtain 9 made by draping of excess fabric from the sleeve 7 created by the joining of the inner surface 4 and outer surface 5 of the tunnel wall 6 so that a void exists between the inner surface 4 and outer surface 5. A tunnel support member 8 is ideally inserted into the sleeve 7 so that it will possess sufficient structural integrity such that the tunnel 6 will not collapse upon itself. The tunnel support member 8 can be foam, cardboard, plastic, or any sufficiently rigid material that can be shaped to encompass the tunnel 6 length so as to keep it from collapsing upon itself. If the tunnel support member 8 is sufficiently flexible it too could function to close the second end 2 of the tunnel 6 so that it could be forced open by burrowing. In this embodiment, the inclusion of a curtain 9 is optional.

An alternative embodiment utilizes cover materials fashioned from fabrics including cotton, polyester, fleece, flannel, blends of the foregoing, and similar materials. The fabric is folded and sewed so that it forms a sleeve that encloses the tube that forms the tunnel of the burrow. One end has a hem and the other end is gathered with an elastic, leaving a smaller opening at one end of the burrow.

The tunnel is preferably made of polyurethane foam or similar materials that can supply the structural integrity required by the burrow tunnel. The foam thickness can be varied but the preferred thicknesses are 1, 2 and 3 inches. The polyurethane foam pad that preferably forms the structural part of the tunnel is cut into three rectangular or trapezoidal shapes that are joined and rolled into a tubular shape, preferably using an adhesive. A typical first rectangular cut of the foam or similar material is 24×42 inches, the second cut is smaller than the first and is typically used as the floor of the tunnel. A third piece is cut even smaller than the second and is attached to the floor of the tunnel so as to form an extended porch or resting area.

Assembly of the device is achieved most easily by curvedly folding the first cut of foam into the tunnel shape and using a commercially available adhesive to adhere to ends of the tunnel to the ends of the floor formed by the aforementioned second cut of the foam. The remaining piece of foam that forms the porch is likewise adhered to the floor at one of the two remaining ends, preferably the end with the larger opening of the tunnel if said tunnel is conical.

The foam structure formed by adhering the aforementioned foam pieces together is then wrapped with the cover which is preferably large enough to cover the exterior and interior of the foam structure. One end of the tunnel, on the side with the porch, is left open for easy ingress and egress while the opposing end is partially, if not completely, covered by gathered fabric.

What is claimed is:

1. A pet enclosure comprising:
a tunnel having a first end and a second end, at least one wall comprising said tunnel, said first end possessing sufficient structural integrity to allow said first end to remain open, said second end possessing insufficient structural integrity to remain open, and said wall having an inner surface and an outer surface.

2. The device of claim 1, wherein said tunnel possesses sufficient structural integrity to remain open.

3. The device of claim 2, wherein said structural integrity of said tunnel is imparted by materials placed between said inner surface and said outer surface of said wall.

4. The device of claim 3, wherein said inner surface and said outer surface form a sleeve having a first end and a second end.

5. The device of claim 4, wherein said sleeve is removable.

6. The device of claim 5, wherein said sleeve is enclosed at said first end and open at said second end.

7. The device of claim 6, wherein said sleeve possesses means for closing said second end.

8. The device of claim 7, wherein said means for closing is selected from the group consisting of buttons, zippers, snaps, VELCRO™, hooks and similar means for fastening known to those skilled in the art.

9. The device of claim 6, wherein said sleeve is comprised of materials selected from the group consisting of textiles, plastics, and fur.

10. The device of claim 3, wherein said first end possesses a means for imparting structural integrity to keep said first end open separate to those placed between said inner surface and said outer surface of said wall of said tunnel.

11. The device of claim 10, wherein said means for imparting structural integrity to keep said first end open is placed within a cuff folded back upon said tunnel wall.

12. The device of claim 11, wherein said cuff is folded back over the outer surface of said tunnel wall.

13. The device of claim 11, wherein said cuff is folded back over the inner surface of said tunnel wall.

14. The device of claim 11, wherein said means for imparting structural integrity is manufactured from materials selected from the group consisting of structural foam, plastic, cardboard, wood, wire and similar materials.

15. A pet enclosure comprising:
a tunnel having a first end with sufficient structural integrity to remain open and a closed second end;
at least one wall comprising said tunnel, said wall having an inner surface and an outer surface joined at one end to form a removable sleeve and possessing a void between said inner and outer surface and further possessing fastening means for securing and closing the open end of said sleeve;
at least one support member inserted within said sleeve to provide structural integrity to said tunnel wall;

16. The device of claim 15, wherein said tunnel possesses sufficient structural integrity to remain open.

17. The device of claim 15, wherein said means for closing is selected from the group consisting of buttons, zippers, snaps, VELCRO™, hooks and similar means for fastening known to those skilled in the art.

18. The device of claim 15, wherein said sleeve is comprised of materials selected from the group consisting of textiles, plastics, and fur.

19. The device of claim 15, wherein said first end possesses a means for imparting structural integrity to keep said first end open separate to those placed between said inner surface and said outer surface of said wall of said tunnel.

20. The device of claim 19, wherein said means for imparting structural integrity to keep said first end open is placed within a cuff folded back upon said tunnel wall.

21. The device of claim 20, wherein said cuff is folded back over a surface of said tunnel wall.

22. The device of claim 15, wherein said means for imparting structural integrity is manufactured from materials selected from the group consisting of structural foam, plastic, cardboard, wood, wire and similar materials.
